(19) United States
(12) Patent Application Publication
(10) Pub. No.: US 2005/0248096 A1
(43) Pub. Date: Nov. 10, 2005

(54) Sealing ring

(76) Inventors: Alain Baudry, Neuilly-Leregre (FR); Bruno Bour, Montlandon (FR)

Correspondence Address: HARNESS, DICKEY & PIERCE, P.L.C., P.O. BOX 828, BLOOMFIELD HILLS, MI, 48303, US

(21) Appl. No.: 11/070,844

(22) Filed: Mar. 1, 2005

(30) Foreign Application Priority Data
Mar. 30, 2004 (DE) 102004016039.2

(51) Int. Cl. F16J 15/32

(52) U.S. Cl. 277/559

(57) ABSTRACT

Sealing ring comprising a support element (1) and a sealing collar (2) and which in sealing manner envelops a machine element (3) to be sealed, wherein the support element (1) and the sealing collar (2) are connected to each other, the support element comprising an axial flange (4), the axial flange (4) being of essentially cylindrical shape and extending in axial direction parallel to the insertion and removal direction (6) of the sealing ring and on the outer circumferential side presenting at least one elevation (7) with at least one support surface (8) extending essentially across the insertion and removal surface (6) and wherein the elevation (7) is enveloped by a cover (10) configured as a static seal (9).

### CROSS-REFERENCE TO RELATED APPLICATIONS

This application claims the benefit of German Patent Application 10 2004 016 039.2, filed Mar. 30, 2004. The disclosure of the above application is incorporated herein by reference.

### FIELD OF THE INVENTION

The present invention relates to a sealing ring.

### BACKGROUND OF THE INVENTION

EP 0 297 166 A1 discloses a sealing ring including a support element and a sealing element. The support element includes an axial flange which, when viewed in the axial direction, is only partly enclosed by a cover made of an elastomeric material. The cover is configured as a static seal. In the region of the cover, the axial flange, when viewed in the circumferential direction, is wavy. The peaks and valleys of the wave extend parallel to the direction of insertion and removal of the sealing ring.

### SUMMARY OF THE INVENTION

An object of the present invention is to provide an improved sealing ring so that, when the sealing ring is inserted into a mounting space and when it is removed from the mounting space, the cover on the outer periphery of the axial flange is substantially more durably connected with the axial flange, and so that a detachment of the cover from the axial flange is reliably prevented.

The objective is reached by means of a sealing ring which comprises a support element and a sealing collar that envelopes, in a sealing manner, a machine element that is to be sealed. The support element and the sealing collar are connected to each other and the support element comprises an axial flange. The axial flange is configured essentially cylindrically and extends in an axial direction essentially parallel to the direction of insertion and removal of the sealing ring. On the periphery of the axial flange is provided at least one elevation that has at least one support surface that extends essentially across the direction of insertion and removal. The elevation is enveloped by a cover configured as a static seal. The static seal consists of a suitable sealing material, for example an elastomeric or polymeric material.

During the mounting or disassembly of the sealing ring, the support surface that extends essentially across the direction of insertion and removal supports the cover that constitutes the static seal. In the case of the claimed sealing ring, the shearing forces that act on the cover and the joint between the axial flange and the cover do not act on the separating surfaces of the axial flange and the cover extending parallel to the insertion and removal direction. In contrast, the shearing forces act essentially vertically on the support surface. In this manner, the risk of the cover detaching itself from the axial flange during the mounting/disassembly of the sealing ring is reduced to a minimum by the support surface that extends across the direction of insertion and removal of the sealing ring.

According to an advantageous embodiment, the cover can have an axial extension that corresponds to the axial extension of the axial flange and completely covers the flange in the axial direction. Such a configuration, too, contributes to the solution of the posed problem, because the contact surface between the axial flange and the cover is unusually large, and the adhesion between the cover and the axial flange is thus unusually good.

The elevation can have, for example, an annular, in itself closed, configuration. All peripheral regions of the cover are thus supported during the mounting and disassembly of the sealing ring.

According to another embodiment, the axial flange can have several elevations disposed so as to be uniformly distributed in the circumferential direction. In addition to the support surfaces oriented across the direction of insertion and removal, each of the elevations has two front faces that are disposed adjacent to each other in the circumferential direction of the sealing ring and extend parallel to the insertion and removal direction. The adjoining front faces of adjacent elevations delimit a gap between the elevations. The alternating arrangement of the elevations and gaps in the circumferential direction provides a relatively large contact surface between the axial flange and the cover so that, as a result of the firm connection between the axial flange and the cover, separation of the parts from one another is not to be feared even under very rigorous mounting conditions. Such a configuration results in a very high load-bearing capacity considering the rotation-symmetrical configuration of the support element. In such an embodiment high axial loads such as those arising, for example, during deep insertion of the sealing ring into a receiving opening of a housing, and high loads in the circumferential direction of the sealing ring exert no adverse effect on the bond between the axial flange and the cover or on the durability of the sealing ring.

The elevations can be arranged in at least one first row along a circumferential line. Such a sealing ring can be made to have small dimensions in the axial direction.

As seen from above the sealing ring, the elevations can be essentially rectangular and have two front faces disposed in the insertion and removal directions opposite each other, wherein each is configured as a support surface for the cover. The fabrication of such rectangular or cube-shaped elevations is relatively simple and inexpensive. The support surfaces and front faces extending in radial direction across and parallel to the direction of insertion and removal provide an unusually large contact surface and thus an unusually efficient and durable support for the cover on the axial flange.

To obtain a further improved support for the cover at the axial flange and thus an improved durability during the mounting and disassembly of the sealing ring, it is possible, as seen in the axial direction of the sealing ring, for at least two rows of elevations extending in the circumferential direction to be disposed on the axial flange. It is also possible for the two rows to be disposed adjacently at an axial distance from each other, with each row disposed along a circumferential line. According to another embodiment, the two rows can be disposed adjacently without being at an axial distance from one another. With the double-row arrangement of the elevations, greater forces can be absorbed than with one that has only a single row. As a result, of good “indentation” between the cover and the axial flange, these parts show excellent durability. The coordination of the elevations of each row relative to the other row in terms of gaps promotes these advantageous use properties. During the mounting and disassembly of the sealing ring in an opening of the housing, the absorption of axial forces which act on the connection between the cover and the axial flange is thus further facilitated.

The support element is preferably made of a polymeric material. The support element consists of a material that is tenacious compared to the sealing collar. The suitability of the polymeric materials depends on the loads acting on the support element. The materials can be fiber-reinforced. The fiber reinforcement brings about an improvement in the mechanical resistance of the materials.

For example, the sealing collar can be made of a polytetrafluoroethylene [PTFE] compound.

On the side radially facing the machine element, the sealing collar can have a reclaiming twist to return the medium to be sealed in the direction of the space to be sealed. The sealing collar, depending on the particular application involved, is pre-arched in or away from the direction of the space to be sealed. The sealing collar made from a PTFE compound in this manner exhibits constantly good use properties over a very long service life.

The sealing collar, however, can also be made of a single-ply or multi-ply nonwoven material bonded with a latex or impregnated with a PTFE dispersion. Moreover, the sealing collar can be made of a duoplastic or thermoplastic polymer that is sufficiently elastically deformable and abrasion resistant.

To achieve good bonding of the sealing collar to the support element, the support element can be provided with a radial flange configured as a single unit of the same material as and integral with the axial flange. The radial flange preferably encloses the outer peripheral surface of the sealing collar in a clamp-like manner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the following, an exemplary embodiment of the sealing ring of the invention will be explained in greater detail by reference to FIGS. 1 to 4. In schematic representation, these figures depict the following.

FIG. 1 shows a longitudinal cross-section of a sealing arrangement comprising a sealing ring according to a principle of the present invention;

FIG. 2 shows a sealing arrangement as in FIG. 1 with the sealing ring cut along line B-B of FIG. 3;

FIG. 3 shows a side view of a sealing ring as shown in FIGS. 1 and 2; and

FIG. 4 is a view in perspective of the support element and the sealing collar connected to each other, without the cover that forms the static seal.

### DETAILED DESCRIPTION OF THE PREFERRED EMBODIMENTS

The following description of the preferred embodiment(s) is merely exemplary in nature and is in no way intended to limit the invention, its application, or uses.

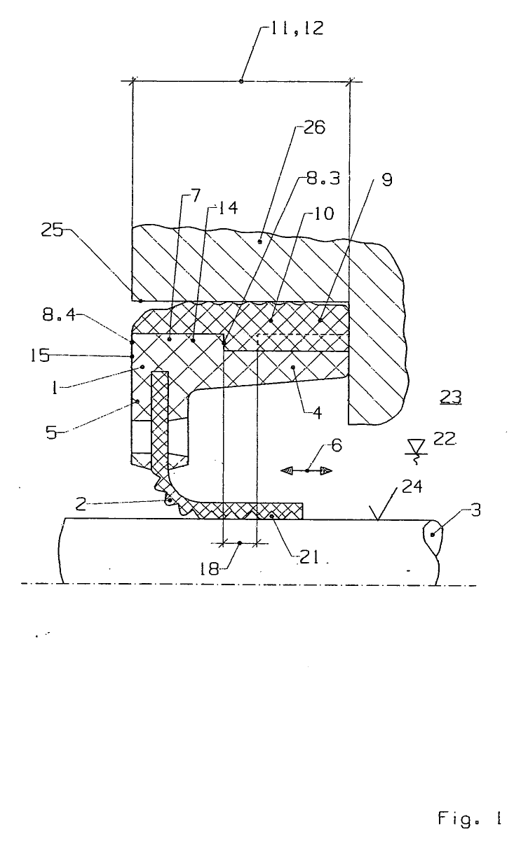

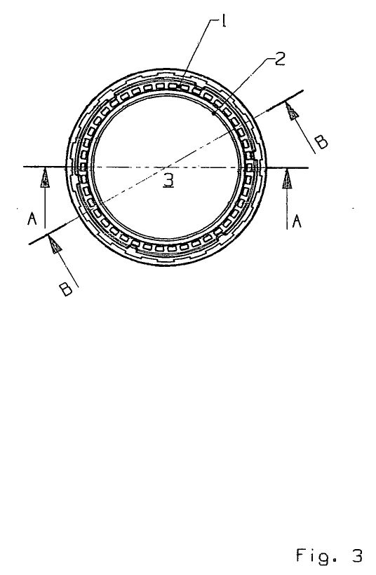

FIG. 1 shows a longitudinal cross-section of the exemplary embodiment of a sealing arrangement. The sealing ring is represented cut along A-A of FIG. 3.

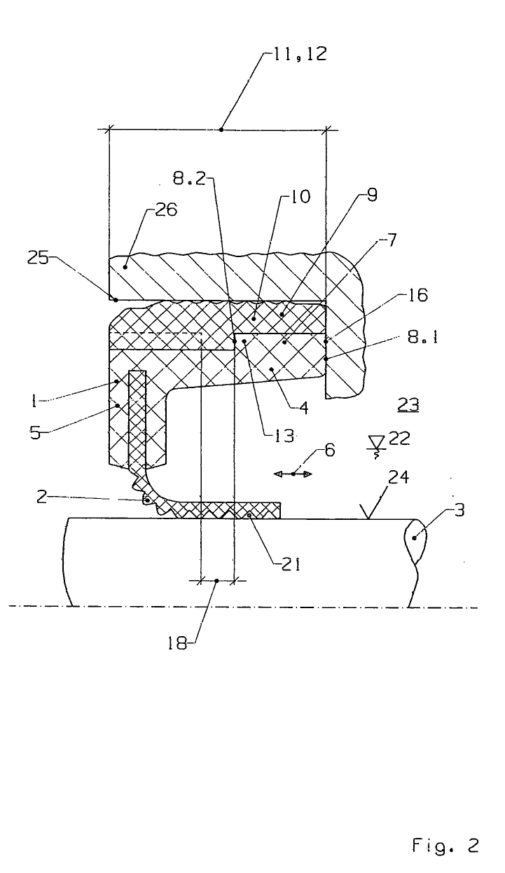

FIG. 2 shows the sealing arrangement of FIG. 1 with the sealing ring cut along line B-B of FIG. 3.

The sealing ring of FIGS. 1 and 2 comprises a support element 1 made of a tenacious polymeric material. Connected with support element 1 is a sealing collar 2 that consists of a sealing material which in the exemplary embodiment shown here is a PTFE compound. The machine element 3 in the exemplary embodiments shown here is formed by a shaft. The sealing collar envelopes, in a sealing manner under initial radial tension, the surface 24 to be sealed of the machine element 3 to be sealed. On the side radially facing machine element 3, the sealing collar 2 is provided with a thread-like reclaiming twist 21 for the purpose of returning a medium 22 that is to be sealed in the direction of space 23 to be sealed. In the exemplary embodiments shown here, the sealing collar 2 is pre-arched in the direction of the space 23 to be sealed. In general, however, it is also possible to provide an essentially equally configured sealing ring, with a sealing collar 2 that is pre-arched away from the direction of space 23 that is to be sealed. Independently thereof, the reclaiming twist 21 is configured so that the medium 22 to be sealed is conveyed back in the direction of the space 23 that is to be sealed.

The support element 1 is provided with an axial flange 4 and a radial flange 5 disposed relative to each other at essentially right angles. Theaxial flange 4 is essentially cylindrical and extends in an axial direction parallel to the insertion and removal direction 6 of the sealing ring.

On its peripheral side, axial flange 4 has a multiplicity of elevations 7, 7.1, 7.2, etc. The elevations 7, 7.1, 7.2, etc. are arranged in at least two rows 13 and 17 that extend in the circumferential direction.

In each row 13 and 17, the elevations 7, 7.1, 7.2, etc. are distributed uniformly in the circumferential direction, and in this exemplary embodiment, the two rows 13 and 17 are disposed adjacently at an axial distance 18. The two rows 13 and 17 extend along circumferential lines 14 and 9, respectively.

When viewed in the circumferential direction of the axial flange 4, the elevations 7, 7.1, 7.2, etc. of the first and second row 13 and 17 are displaced by the length of a gap 20.

In essence, support surfaces 8.1 and 8.2 of the elevations 7, 7.1, 7.2, etc.extend in an essentially radial direction and across the insertion and removal direction 6. On the support surfaces 8.1 and 8.2, the cylindrical axial flange extends in an essentially axial direction parallel to the insertion and removal direction 6 and provides, during the mounting/disassembly of the sealing ring in an opening 25 of a housing 26, excellent support for the polymeric material that constitutes a cover 10 which forms a static seal 9. As a result of the arrangement and configuration of support surfaces 8.1 and 8.2, even under rigorous mounting conditions involving, for example, the use of automatic mounting tools, the separation of the cover 10 from the axial flange 4 is nearly impossible. A reliable connection of the cover 10 with the axial flange 4 is also promoted by the fact that the cover 10 is provided with an axial extension 11 that corresponds to an axial extension 12 of the axial flange 4 and completely covers the flange in the axial direction.

In the exemplary embodiment shown here, the static seal 9 consists of a polymeric material.

In FIG. 3, the sealing ring of FIGS. 1 and 2 is shown from a side view.

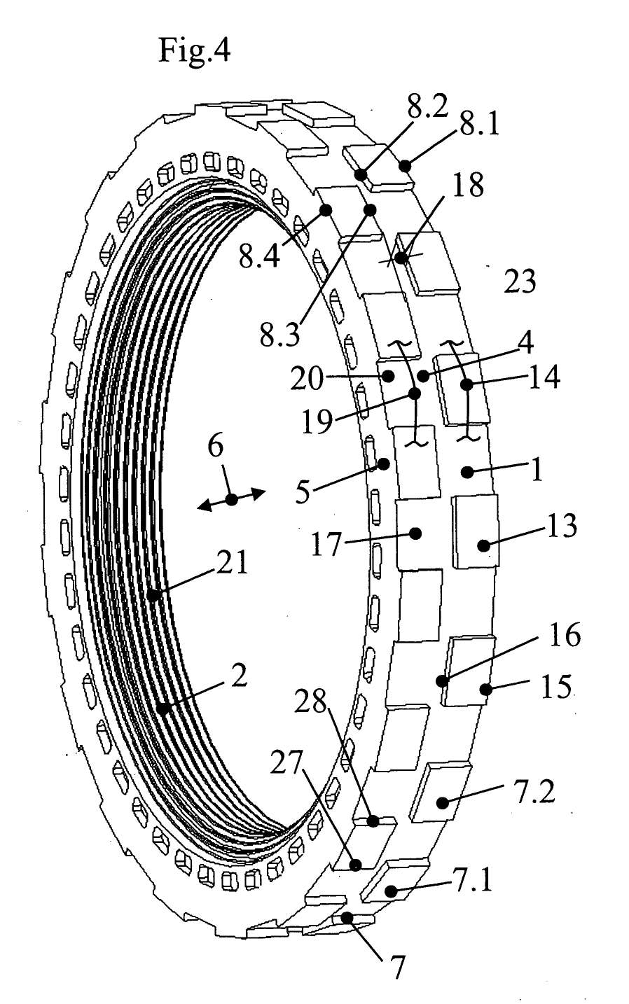

In FIG. 4, parts of the sealing ring of FIGS. 1 and 2 are shown from a perspective view. For greater clarity, the cover 10 configured as the static seal 9 on the outer circumference of the axial flange 4 has been omitted.

The elevations 7, 7.1, 7.2, etc. which are disposed on the outer circumference of the axial flange 4 and, respectively, extended in two rows 13 and 17 along circumferential lines 14 and 19 are provided with support surfaces 8.1 and 8.2 oriented across the insertion and removal direction 6 so that each elevation 7, 7.1, 7.2, etc. is limited in the circumferential direction of the axial flange 4 by two front faces 27 and 28.

The elevations 7, 7.1, 7.2, etc. of the first and second row 13 and 17 are, when viewed in the circumferential direction of the flange 4, displaced by the length of the gap 20. The axial distance between the two rows 13 and 17 are indicated by reference numeral 18.

The description of the invention is merely exemplary in nature and, thus, variations that do not depart from the gist of the invention are intended to be within the scope of the invention. Such variations are not to be regarded as a departure from the spirit and scope of the invention.

1. A sealing ring which in sealing manner envelopes a machine element to be sealed, comprising:
a support element and a sealing collar connected to each other, the support element comprising an axial flange, the axial flange being of an essentially cylindrical shape and extending in an axial direction parallel to an insertion and removal direction of the sealing ring, and on an outer circumferential side presents at least one elevation with at least one support surface that extends essentially across the insertion and removal surface of the sealing ring;
wherein the elevation is enveloped by a cover that is configured as a static seal.

2. The sealing ring as defined in claim 1, wherein the cover has an axial extension that corresponds to an axial extension of the axial flange and completely covers the flange in an axial direction.

3. The sealing ring as defined in claim 2, wherein the axial flange is provided with a plurality of elevations uniformly distributed in a circumferential direction.

4. The sealing ring as defined in claim 3, wherein the elevation are arranged in at least one first row along a circumferential line.

5. The sealing ring as defined in claim 3, wherein the elevation, are of an essentially rectangular shape and are provided with two front faces that face each other in the insertion and removal direction, each elevation being configured as a support surface for the cover.

6. The sealing ring as defined in claim 3, wherein the elevations are disposed on the axial flange in at least two rows that extend in the circumferential direction, the two rows being disposed adjacently to each other at an axial distance, and each row being disposed along one circumferential line.

7. The sealing ring as defined in claim 6, wherein the elevations of the first and second row are displaced from one another by a length of a gap.

8. The sealing ring as defined in claim 1, wherein the support element consists of a polymeric material.

9. The sealing ring as defined in claim 1, wherein the sealing collar consists of a PTFE compound.

10. The sealing ring as defined in claim 1, wherein on a side radially facing the machine element the sealing collar is provided with a reclaiming twist for returning a medium to be sealed in a direction of a space to be sealed.
